(19) United States
(12) Patent Application Publication
(10) Pub. No.: US 2006/0217946 A1
(43) Pub. Date: Sep. 28, 2006

(54) Driver's cab of a motor vehicle with optimised air flow characteristics and method for optimising the aerodynamics of a driver's cab of a motor vehicle

(75) Inventor: Thorsten Frank, Aidingen (DE)

Correspondence Address: CROWELL & MORING LLP;INTELLECTUAL PROPERTY GROUP, P.O. BOX 14300, WASHINGTON, DC, 20044-4300, US

(73) Assignee: DaimierChrysler AG, Stuttgart (DE)

(21) Appl. No.: 10/544,634

(22) PCT Filed: Dec. 5, 2003
(86) PCT No.: PCT/EP03/13770

§ 371 Date: Apr. 6, 2006

(30) Foreign Application Priority Data
Feb. 14, 2003 (DE) 103 06 162.2

(51) Int. Cl. G06G 7/48

(52) U.S. Cl. 703/8

(57) ABSTRACT

A driver's cab (10) of a vehicle having optimized air flow characteristics and a method for optimizing the aerodynamics of a driver's cab (10) of a motor vehicle are proposed, it being possible by means of air flow tests to determine a number of design parameters (A-H) with regard to their aerodynamic influence, the parameters (A-H) within a predefined range of variation being optimized jointly and as a function of one another with a view to optimum overall air flow characteristics of the external shape of the driver's cab (10).

### BACKGROUND AND SUMMARY OF THE INVENTION

This application claims the priority of German patent document 103 06 162.2, filed Feb. 14, 2003 (PCT International Application No. PCT/EP2003/013770, filed Dec. 5, 2003), the disclosure of which is expressly incorporated by reference herein.

The invention relates to a driver's cab of a motor vehicle, such as a truck, having optimized air flow characteristics or aerodynamics, and to a method for optimizing the aerodynamics of a driver's cab of a motor vehicle.

The aerodynamic properties of vehicles vary as a function of the shape of the bodyshell (such as the unity of an external bodyshell shape, for example) and efforts have been made to obtain the lowest possible air resistance and hence the lowest possible drag coefficient (cw value). Because low air resistance also achieves a reduction in the vehicle fuel consumption, in modern vehicle development extensive wind tunnel testing is carried out before the ultimate shape of a vehicle bodyshell or a driver's cab of a truck is finalized.

Other design measures can also be taken to improve the aerodynamics and hence the drag coefficient of vehicle cabs for trucks. For example, German patent document DE 3823161 A1 discloses height-adjustable wind baffles which can be fitted, in particular, to truck cabs to improve the drag coefficient of the truck. Such wind baffles, however, are fitted to a given truck cab by means of separate fixing devices, and the transitions between the cab and the wind baffle constitute aerodynamic problem zones. All in all the aerodynamic improvement is unsatisfactory.

German patent document DE 8119436.6 U1 discloses a wind and or flow baffle that is mounted on an existing driver's cab, finishing flush with the front and side edges of the driver's cab. Even in this case, however, the improvement in the drag coefficient is nevertheless still limited, the given external shape of the cab bodyshell preventing any further improvement. The external shape of the driver's cab, influenced decisively by the technical design construction, is relatively angular and leads to turbulence, and hence to an increased air resistance.

Accordingly, one object of the present invention is to provide a driver's cab for a vehicle having optimized aerodynamic properties and air flow characteristics.

Another object of the invention is to provide a method for optimizing the aerodynamic properties of a driver's cab of a motor vehicle.

These and other objects and advantages are achieved by the method and apparatus according to the invention, in which the driver's cab of a vehicle has a plurality of design parameters which determine the drag coefficient of the vehicle, and which are optimized for airflow purposes. The aerodynamic influence of each of the design parameters on the vehicle bodyshell can be determined in air flow tests. The design parameters of the driver's cab according to the invention can each be varied within a predefined fixed range, and within the predefined range of variation they are optimized jointly (as a function of one another) with a view to optimum overall air flow characteristics of the external shape of the driver's cab.

In this manner, an overall optimum drag coefficient for the driver's can be achieved by varying a number of design parameters of the driver's cab. The driver's cab is still formed within a given design framework, but nevertheless has improved aerodynamic properties in terms of a reduced drag coefficient compared to those driver's cabs or vehicles in which design parameters, such as the windshield inclination or the integrity of the external shape would only have been optimized in isolation by means of wind tunnel testing. According to the invention, all the design parameters for overall aerodynamics are determined jointly and in coordination with one another on the driver's cab, so that the driver's cab has a better overall drag coefficient than existing driver's cabs. Extreme values for the individual design parameters, such as an extremely shallow windshield inclination, which are unacceptable for non-aerodynamic reasons, are avoided. The driver's cab retains, within certain limits, a bodyshell shape consistent with the functionality and the vehicle-specific requirements, but is fully optimized in terms of the aerodynamics.

In an advantageous embodiment of the invention, the design parameters of the driver's cab that influence its air flow characteristics are optimized in conjunction with one another and in predefined steps by means of a computer. The predefined stages or steps in which the parameters are varied reduces the design and development costs of the driver's cab. Coherent optimization by means of a computer ensures that the individual design values of the driver's cab are determined in overall correlation and not each in their individual effect on the aerodynamics of the vehicle. The latter approach would only result in a less than optimum drag coefficient.

In a further advantageous embodiment of the invention the external geometric shape and the edge shape of the driver's cab are aerodynamically optimized as a function of one another. It has been determined that the edge shape of the bodyshell, in particular, and the external geometric shape (that is, the width, height and length) of driver's cabs, have a substantial influence on the overall aerodynamics of a driver's cab and a vehicle bodyshell. The aerodynamically and coherently optimized parameters of the edge shape and external geometric shape of the driver's cab serve largely to prevent turbulence, and thereby sources of air resistance. The flow resistance is thus reduced.

According to still another embodiment of the invention the end face area of the driver's cab is optimized, coordinating its external shape with the air flow within predefined limits and in predefined steps for the design parameters of the end face area. This measure alone makes it possible to achieve a considerable improvement in the aerodynamics, and hence a considerable reduction in the fuel consumption. Merely through the number of design parameters which affect the end face area of a driver's cab (which in the state of the art generally has a relatively angular front inclining downwards in a straight line), it is possible to improve the aerodynamics of the driver's cab without greatly influencing the technically essential design shaping.

According to another feature of the invention, the driver's cab design parameters which are optimized as a function of one another in predefined steps are selected from the following group:

a) Width of driver's cab

b) Height of driver's cab

c) Length of driver's cab

d) Corner radius

e) Sweepback

f) Taper

g) Roof radius

h) Windshield inclination

Surprisingly, it has been determined that these particular cab design parameters, in their overall correlation, have a considerable influence on the aerodynamic properties of the driver's cab, which can be optimized by varying such parameters, provided that they are set within given limits. The driver's cabs according to the invention therefore do not have any extreme individual parameter values, such as an extremely shallow inclination of the windshield or an extremely rounded corner radius. Rather, they are optimized within the context of an acceptable design modification of the aforementioned parameters relevant to the aerodynamics. A considerable improvement was obtained in terms of the drag coefficient (c_{w} value).

The method according to the invention for optimizing the aerodynamics of a driver's cab of a motor vehicle by determining a plurality of design parameters includes:
Analysis of the aerodynamic influence of each individual design parameter in wind tunnel testing within a predefined range;
Selection of an optimum value for each parameter as a function of the joint, cumulative influence of the parameters on the overall flow resistance (or drag coefficient) of the driver's cab; and
Calculation of the parameter values from the individual parameter results.

In this way it is possible to improve the drag coefficient of driver's cabs solely by a specific variation of design parameters that strongly influence its aerodynamic properties. In each case, the design parameters are optimized in overall correlation, and observing limits. Extreme values for individual parameters are thus avoided. The costs of the method are contained, since the scope for varying individual parameters is defined on the one hand by upper and lower limits, and on the other by predefined steps in the parameter values. It has been shown that in this way, within the framework of design and vehicle construction limits, it is possible to achieve a considerable improvement in the aerodynamics of driver's cabs, particularly of trucks.

According to a further advantageous embodiment of the method according to the invention the parameters are each predefined in a specific graduation in the range of variation, which reduces the cost of implementing the method. The results in the parameter values are, moreover, unambiguous and avoid odd intermediate values. The graduation of the parameter values also has the advantage that relatively few computer calculations and relatively short computer times are required for carrying out the method.

In another advantageous embodiment of the invention, the design parameters undergo two-dimensional analysis for their respective influence on the aerodynamic resistance of the driver's cab, and are then fixed by means of a computer through three-dimensional evaluation and synthesis of each of the optimum values. The individual steps of analyzing the individual influences by two-dimensional evaluation and then combining them in a computer step for overall optimization have proved expedient. The cost of calculating and determining the resulting parameter values is minimized.

According to the invention a number of design parameters can be optimized, selected from the following group:

a) Width of driver's cab

b) Height of driver's cab

c) Length of driver's cab

d) Corner radius

e) Sweepback

f) Taper

g) Roof radius

h) Windshield inclination

These design measures can each be varied within predefined limits without excessive restrictions on the design or feasibility requirements for driver's cabs for vehicles, especially trucks, and each has a separate and determinable individual influence on the air resistance and the aerodynamics of the driver's cab. In the case of a negative influence on the air flow or the air resistance it is precisely these parameters which cumulatively produce an extremely negative drag coefficient of the overall vehicle. For this reason it has been determined that a joint, coordinated optimization of these parameters leads, within prescribed limits, to unexpected improvements in the aerodynamics of vehicles.

Other objects, advantages and novel features of the present invention will become apparent from the following detailed description of the invention when considered in conjunction with the accompanying drawings.

### BRIEF DESCRIPTION OF THE DRAWINGS

FIG. 1 shows a top view of a driver's cab of a truck according to an exemplary embodiment of the invention; and

FIG. 2 shows a table of optimized values of design parameters of the driver's cab according to the exemplary embodiment in FIG. 1.

### DETAILED DESCRIPTION OF THE DRAWINGS

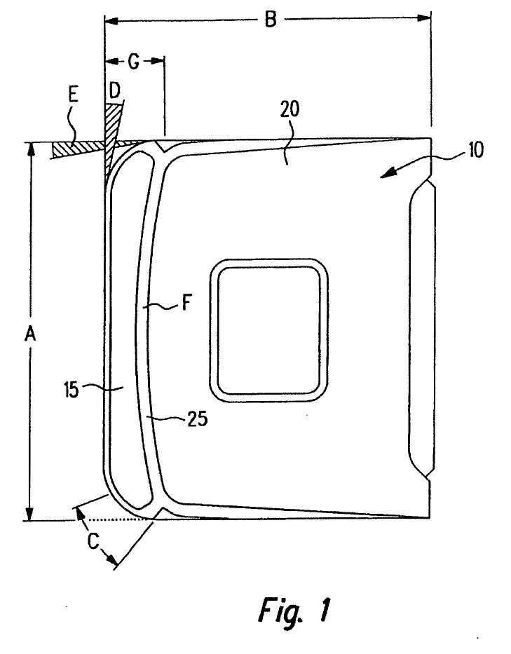

The driver's cab 10, represented schematically in a top view in FIG. 1, has a slightly inclined windshield 15, which merges via a driver's cab edge or roof edge 25 into a roof 20 of the driver's cab. The driver's cab 10 has a number of variable design parameters, which according to the invention are optimized in coordination with one another in regard to the overall drag coefficient or cw value (that is, the overall aerodynamics of the driver's cab). In this representative embodiment the design parameters of the driver's cab are:

A: Width of driver's cab

B: Length of driver's cab

C: Corner radius (or edge rounding)

D: Sweepback

E: Taper

F: Roof radius

G: Windshield inclination

H: Height of driver's cab (not visible in the figure)

These design parameters of the driver's cab all have a specific value, which is optimized from a predefined variation range, and as a function of the individual influences of the parameters on the aerodynamics of the driver's cab having regard to the overall aerodynamics. The external shape of the driver's cab 10 is nevertheless arrived at within the essential technical and feasibility limits. None of the individual parameters is exaggerated through extreme design, for example the windshield inclination G, which obviously by itself, would have an optimum drag coefficient at an extremely shallow angle of inclination.

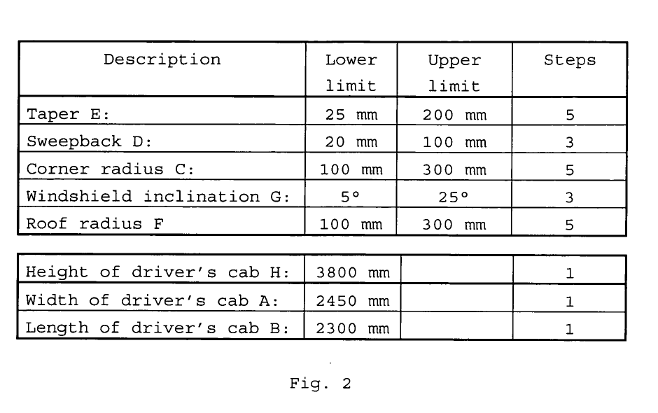

FIG. 2 is a table of exemplary values for design parameters as specified above, which illustrates how such a driver's cab with optimized overall aerodynamics can be achieved by a method according to the invention. The respective design parameters A to H are defined by a lower limit and an upper limit in a predefined range. For each parameter, gradations or steps are moreover laid down, in which this parameter may be varied.

In this exemplary embodiment according to FIG. 2 the height of the driver's cab H, the width of the driver's cab A and the length of the driver's cab B are predefined. It is also apparent, however, that these parameters could also be variable in fixed gradations, or steps, and within fixed ranges. In the same way it is also possible to optimize just some of the parameters selected from the table in FIG. 2 as a function of one another.

After fixing these limits and gradations for the parameters, according to the invention the aerodynamic influence of each individual parameter within a predefined range is analyzed by means of wind tunnel tests. The individual parameters can also be analyzed by simulation programs or the like. The joint optimization of the values with a view to the overall drag coefficient of the driver's cab leads to the parameter values for the taper E, the sweepback D, the corner radius C, the roof radius F and the windshield inclination G given as examples. The sweepback D is in this case the taper of the cab front from the center towards the side (see FIG. 1), whereas the taper E represents the angling of the side face of the driver's cab in relation to a line running parallel to the central longitudinal axis of the vehicle (see FIG. 1).

The invention is obviously not limited to the design parameters given and may comprise just some of the parameters or also other design parameters of driver's cabs.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1.-9. (canceled)

10. A driver's cab of a vehicle having optimized air flow characteristics, which are defined by a plurality of design parameters, each of which has an influence on the aerodynamic properties of the cab that can be determined by air flow tests, wherein:
said design parameters include parameters that characterize an end face area of the driver's cab;
each parameter can be varied within a predefined fixed range;
within the predefined range, the design parameters are optimized jointly and as a function of one another, first by a two-dimensional analysis of the individual parameters; and
the design parameters are thereafter optimized by a three-dimensional evaluation and synthesis of pairs of optimized parameter values thus obtained for their joint influence on overall drag coefficient with a view to optimum overall air flow characteristics of the external shape of the driver's cab.

11. The driver's cab according to claim 10, wherein the aerodynamics of the external geometric shape and the edge shape of the driver's cab are optimized as a function of one another.

12. The driver's cab according to claim 11, wherein the end face area of the driver's cab is optimized by coordinating its external shape with the air flow within predefined limits and in predefined steps.

13. The driver's cab according to claim 12, wherein the design parameters optimized in coordination with one another are selected from the group consisting of:
driver's cab width,
driver's cab height.
driver's cab length,
Corner radius,
Sweepback,
Taper,
Roof radius, and
Windshield inclination.

14. A method for optimizing aerodynamics of a driver's cab of a motor vehicle, said method comprising:
defining a plurality of design parameters, each of which has an individual aerodynamic influence that can be determined by air flow tests;
analyzing the aerodynamic influence of each of the individual design parameters of the driver's cab in wind tunnel testing within a predefined range;
selecting an optimum value for each parameter as a function of joint, cumulative influence of the parameters on an overall drag coefficient of the driver's cab; and
calculating optimum parameter values from the individual parameter results.

15. The method according to claim 14, further comprising: defining a specific gradation of the parameters in the respective range of variation.

16. The method according to claim 15, wherein said calculating step comprises:
two-dimensional analysis of the parameters for their respective influence on the drag coefficient (c_{w}) of the driver's cab; and
three-dimensional evaluation and synthesis of each of the optimum parameter values using a computer.

17. The method according to claim 16, wherein design parameters which are optimized are selected from the group consisting of:
Width of driver's cab,
Length of driver's cab.
Height of driver's cab,
Corner radius,
Sweepback,
Taper,
Roof radius, and
Windshield inclination.

18. A method for optimizing the aerodynamic properties of a driver's cab of a motor vehicle, said method comprising:
defining a plurality of design parameters that characterize an end face area of the driver's cab, each of which has an individual aerodynamic effect that can be determined by air flow tests;
analyzing the aerodynamic effect of each design parameter in wind tunnel testing of the driver's cab, within a predefined range;
calculating optimum parameter values from the individual parameter results for parameters selected from the group consisting of width of driver's cab, length of driver's cab, height of driver's cab, corner radius, sweepback, taper, roof radius, and windshield inclination, taper, roof radius, and windshield inclination; and
selecting an optimum value for each parameter as a function of a joint, cumulative influence of the parameters on the overall drag coefficient of the driver's cab by
a) two-dimensional analysis of the parameters for their respective influence on the drag coefficient (c_{w}) of the driver's cab; and
b) three-dimensional evaluation and synthesis of each of the optimum parameter values by means of a computer.
